(19) United States
(12) Patent Application Publication
(10) Pub. No.: US 2012/0040324 A1
(43) Pub. Date: Feb. 16, 2012

(54) REMOTELY CONTROLLED BIOMIMETIC ROBOTIC FISH AS A SCIENTIFIC AND EDUCATIONAL TOOL

(75) Inventors: Maurizio Porfiri, Brooklyn, NY (US); Vladislav Kopman, New York, NY (US); Nicole Abaid, Brooklyn, NY (US)

(73) Assignee: Polytechnic Institute of New York University, Brooklyn, NY (US)

(21) Appl. No.: 13/207,552

(22) Filed: Aug. 11, 2011

Related U.S. Application Data
(60) Provisional application No. 61/372,894, filed on Aug. 12, 2010.

(51) Int. Cl. G09B 23/00

(52) U.S. Cl. 434/276

(57) ABSTRACT

Remotely controlled and miniature biomimetic robotic fish for use as a scientific and educational tool, flexible and robust enough to be used for education from kindergarten through college level curricula, and including modular features that allow students to interact with the design of the robot based on observation of nature.

### STATEMENT OF RELATED APPLICATIONS

This patent application claims the benefit under 35 USC 120 of U.S. Provisional Patent Application No. 61/372,894 having a filing date of 12 Aug. 2010.

### BACKGROUND OF THE INVENTION

1. Technical Field

The invention generally relates to the field of scientific and educational tools and learning and more specifically relates to the field of employing biomimetic robotic devices as scientific and educational tools, particularly in pre-college and pre-university youth and for the science, technology, engineering, and mathematics disciplines.

2. Prior Art

Engineering disciplines such as biomedical, chemical, civil, electrical, and mechanical play essential roles in the everyday lives of our society, yet the interests of kindergarten through 12^{th} grade (K-12) students in the United States in these and other engineering fields is fading. It is therefore critical to excite young minds about science, technology, engineering, and mathematics (STEM), in particular to underserved and minority populations with limited access to technology. Interactive robots have been proposed in the literature to reach out to students and the general public as a means to spark interest in STEM fields.

Previous outreach programs include using robotics, such as LEGO MINDSTORMS brand or the Parallax BASIC Stamp II, to motivate interest in STEM fields. These types of robotic instruments are successful in developing logical thinking and engineering practices in students, but they may not entirely encompass ideas about biologically-inspired design and often are too expensive for implementation in every curriculum. The biomimetic robotic fish of the present invention offers a low-cost solution to an interactive hands-on curriculum for STEM in K-12 and higher education.

Robotic fish are known generally, both as subjects of research and as toys. For example, see http://web.mit.edu/newsoffice/2009/robo-fish-0824.html, www.robotic-fish.net, http://ieeexplore.ieee.org/xpl/freeabs_all.jsp?arnumber=5272397, and www.egr.msu.edu/˜xbtan/Papers/iros06_fish.pdf. However, such robotic fish are generally expensive research tools or inexpensive toys, and do not function as scientific and educational tools.

Accordingly, there is a need for a biomimetic robotic fish device for use as a scientific and educational tool and as a low-cost solution to an interactive hands-on curriculum for STEM in K-12 and higher education. It is to these needs and others that the present invention is directed.

### BRIEF SUMMARY OF THE INVENTION

Briefly, the invention comprises a remotely controlled and miniature biomimetic robotic fish as a scientific and educational tool. The robot is flexible and robust enough to be used for education from kindergarten through college level curricula.

The robotic fish of the present invention includes modular features that allow students to interact with the design of the robot based on observation of nature. For one example, students can design and create custom caudal fins to attach to the robotic fish. The robot has the capacity to interface with a computer and may be controlled with any program, by using any programming language, or with a designated remote control.

The system of the present invention may be adjusted depending on the grade and knowledge of the students. In its simplest mode, the robotic fish may be remotely controlled to swim and allow the students to attach their custom made caudal fins to learn and understand how the shape and properties of the caudal fin affects the movement and locomotion of fish. More advanced modes can allow students to create their own graphical user interface (GUI) to control the fish, which is useful for computer science education. Even more refined applications include autonomous operation of the robotic fish using a computer and onboard and external sensors such as digital compasses, accelerometers, gyroscopes, and video cameras. The autonomous operation algorithms can be programmed using a variety of input languages and software allowing the use of the system in courses such as undergraduate controls and mechatronics.

These features, and other features and advantages of the present invention will become more apparent to those of ordinary skill in the relevant art when the following detailed description of the preferred embodiments is read in conjunction with the appended drawings.

### BRIEF DESCRIPTION OF THE DRAWINGS

FIG. 1 is an exploded view of a representative embodiment of the robotic biomimetic fish of the present invention.

FIG. 2 is a view of a representative remote control for robotic biomimetic fish of the present invention.

FIG. 3 is a view of a representative graphical user interface for advanced control of robotic biomimetic fish of the present invention.

FIG. 4 is a top view representation of the robotic biomimetic fish illustrating steering with tail beat amplitude x; (a) swimming straight with n=0 degrees; (b) steering right with n=−20 degrees.

FIG. 5 is a perspective view of representative embodiments of the robotic biomimetic fish of the present invention.

FIG. 6 is a perspective view of representative embodiments of the robotic biomimetic fish of the present invention shown with a camera.

FIG. 7 is a perspective view of a representative embodiment of a completed robotic fish with its body cap open and showing the power and control electronics along with the battery and servomotor.

FIG. 8 is a representative assessment survey for completion by students before participating in the activity of the present invention.

FIG. 9 is a stacked bar graph of student agreement percentages before and after participating in the activity of the present invention.

### DETAILED DESCRIPTION OF PREFERRED EMBODIMENTS

The present invention comprises a remotely controlled and miniature biomimetic robotic fish as a scientific and educational tool. The robot is flexible and robust enough to be used for education from kindergarten through college level curricula and includes modular features that allow students to interact with the design of the robot based on observation of nature. In one illustrative embodiment, students can design and create custom caudal fins to attach to the robotic fish. In another illustrative embodiment, students can program the operation of the fish to autonomously respond to various stimuli. The robotic fish has the capacity to interface with a computer and can be controlled with any program or using any programming language.

The system of the present invention is adjustable in scope and complexity depending on the level of the students. In a simple embodiment, the robotic fish may be remotely controlled to swim. In another simple mode, students can design caudal fins for the robotic fish and attach their custom made caudal fins to learn and understand how the shape of the caudal fin affects the movement and locomotion of fish. More advanced embodiments can allow students to create their own graphical user interface (GUI) to control the fish, which is useful for computer science education. Even more complex embodiments can include autonomous operation of the robotic fish using a computer and onboard and external sensors such as digital compasses, accelerometers, gyroscopes, and video cameras. The autonomous operation algorithms can be programmed using a variety of input languages and software allowing the use of the system in courses such as undergraduate controls and mechatronics.

Referring now to the figures, the robotic fish 10 is comprised of a plastic material and includes a body 12 containing power and control electronics 16 and a tail section 14 for propulsion. The onboard electronics 16 include a microcontroller unit for processing, a wireless transmitter for communication, and a rechargeable battery. A servomotor 70 is used to actuate the tail section 14 of the robotic fish 10, effectively propelling it through the water. The robotic fish 10 is remotely operated via a remote control 50 or through a computer interface.

The onboard robot electronics 16 comprise a microcontroller for computing, a wireless transceiver for communication, sensors for telemetry, a waterproof servomotor for actuation, and a battery. The remote control 50 includes a microcontroller 52, a joystick 54 for steering and tail beat frequency adjustment, a knob 56 for tail beat amplitude adjustment, status LEDs 58, and a remote/computer mode selection switch 60.

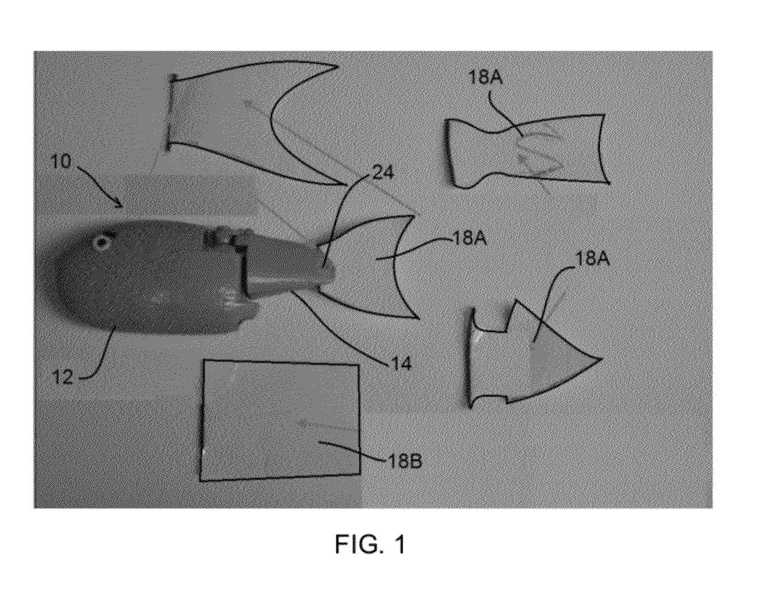

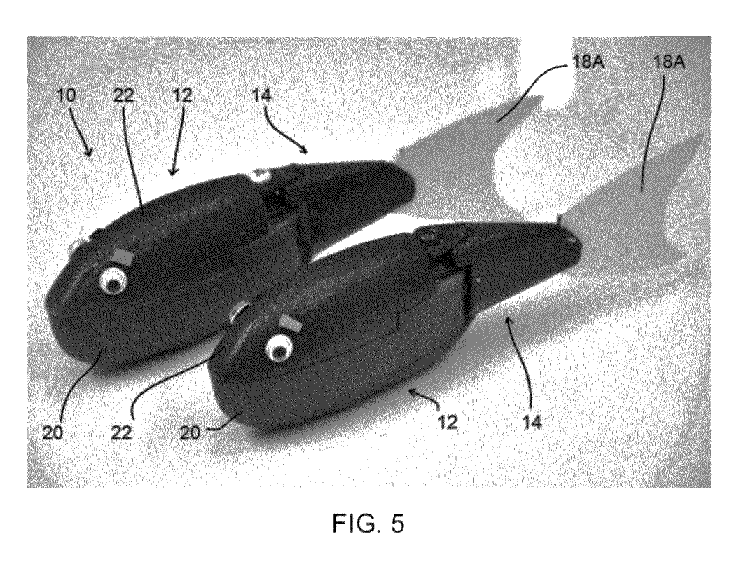

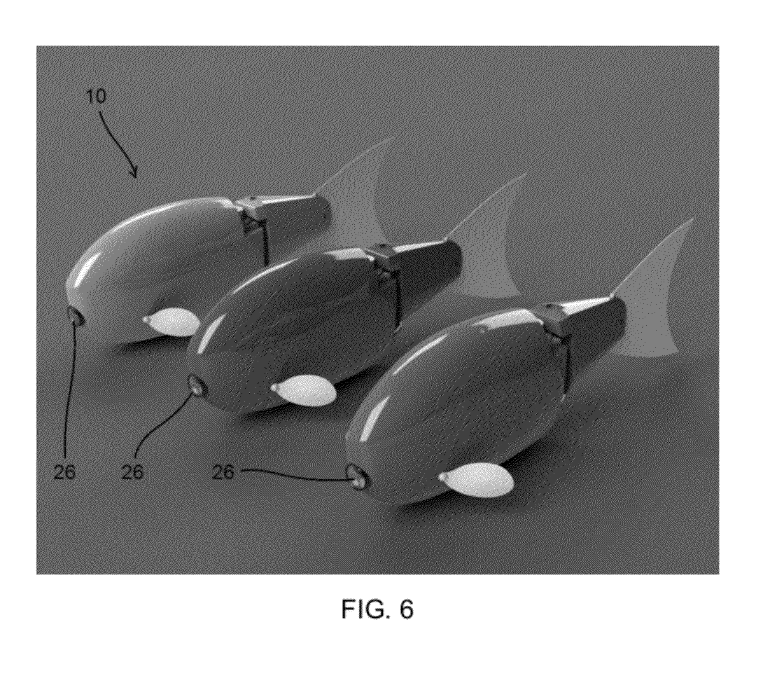

A main feature of the invention lies in the application of the low cost robotic fish 10 as a whole rather than the mechanics of the design itself. In its entirety, the robotic fish 10 provides a platform for kindergarten through college level education. That is, the robotic fish 10 system includes a multitude of modular features allowing users to directly interact with the system. One such feature, illustrated in FIG. 1, is the ability to attach a customized caudal fin 18A, cut from a caudal fin template 18B, to the robotic fish's tail section 14, giving users the ability to design part of the robotic fish 10 to influence better swimming. This particular feature is intended for younger users, namely, up to early middle schoolers, but may be interesting and exciting for users of any age. Representative examples of embodiments of complete robotic fish 10 according to the present invention as shown in FIGS. 5 and 6.

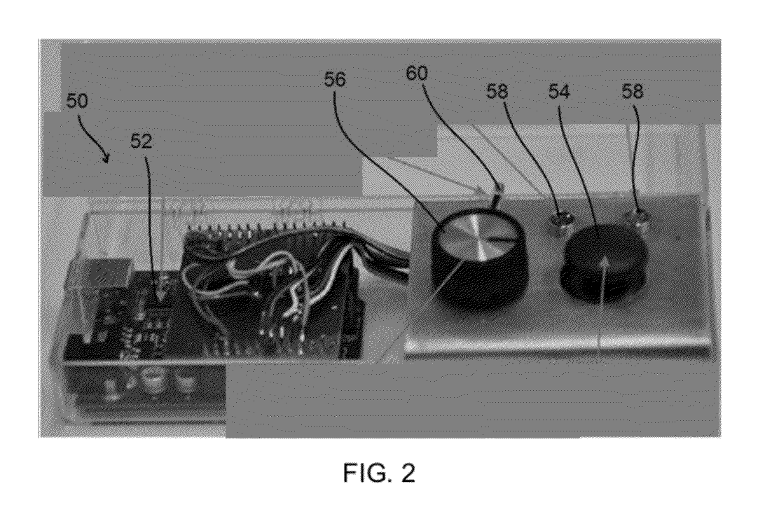

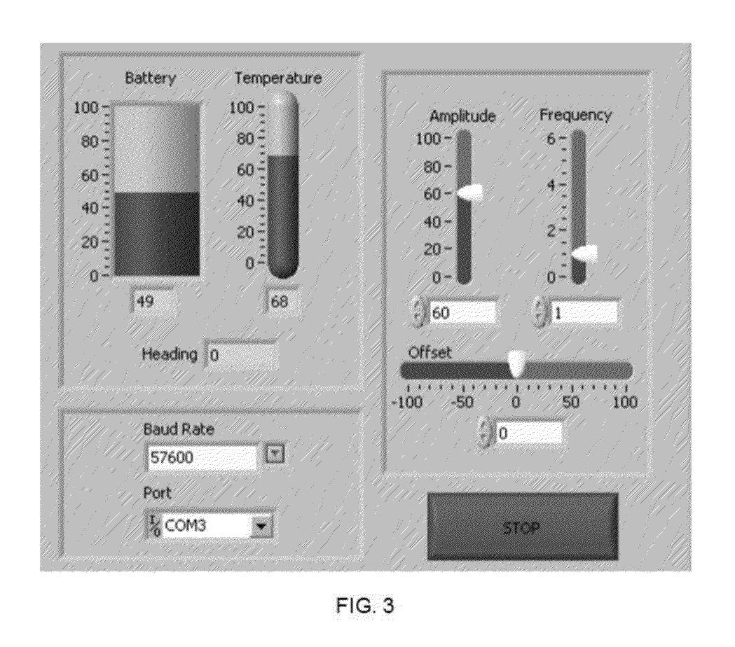

The remote control interface also is novel. The robotic fish 10 is operated using a custom designed remote control 50, as illustrated in FIG. 2. The remote control 50 houses a miniature joystick 54, similar to ones common in video game system controllers, and a knob 56 for steering the robotic fish 10. In addition, the remote control 50 includes a USB interface to a computer for advanced driving of the robotic fish 10. This provides direct access to control parameters such as tail beating amplitude, frequency, and offset through a graphical user interface (GUI) as illustrated in FIG. 3. The GUI includes telemetry from the robotic fish 10. In one embodiment, robot heading, battery voltage, and water temperature are available to the operator. This added control aspect allows the use of the robotic fish 10 as a scientific platform for a variety of research topics.

The illustrative embodiment of the GUI was developed using a commercially available software package called LabVIEW, which is commonly used in university and research laboratories, in industry, and even in some high school classes. Using this or other software packages, a custom graphical user interface may be designed to fit the needs of the operator. This allows the platform to be used in a classroom setting as a proof of concept for a variety of topics, including programming and automatic controls. Other software packages may be used to interface with the remote control for added compatibility using standard serial protocol.

The remotely operated platform comprising the robotic fish 10 and the remote control 50 may be easily converted into an autonomous system via application specific hardware upgrades and/or programming revisions. That is, control algorithms may be developed on the computer and may utilize onboard or external sensors, such as an overhead camera, for feedback. This may find useful application in controls laboratory classes or for education-based competitions.

It is envisioned that the invention will supplement the already wide array of educational tools available on the market. The system is robust enough to easily be modified to serve lower and higher education applications and is advanced enough to accommodate fundamental research project needs. The low cost and wide applicability of the system is advantageous to education and research budgets.

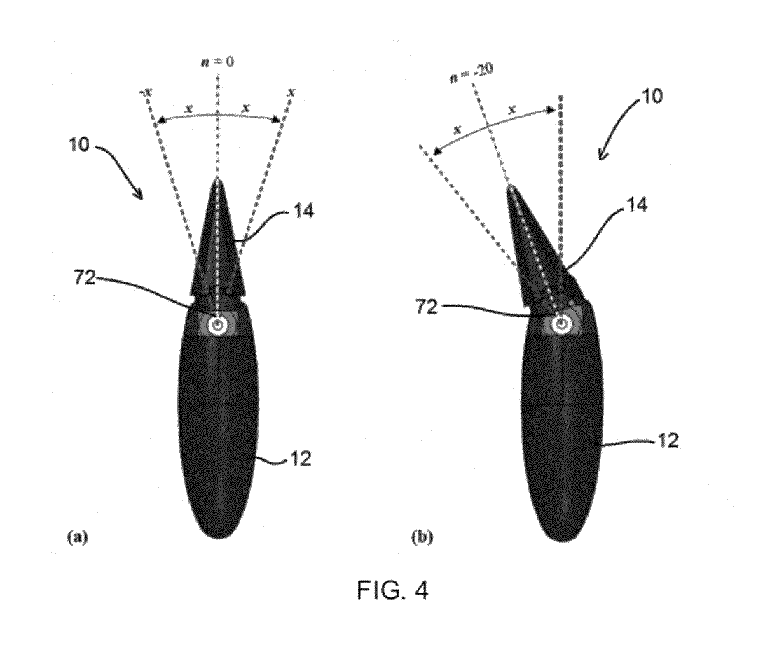

In operation, the robotic fish 10 undulates in a manner similar to live fish. This allows the robotic fish 10 to replicate the locomotion of carangiform swimmers such as goldfish or minnows, demonstrating a biologically-inspired design. Referring to FIG. 4, the robotic fish 10 uses a single servomotor 70 for propulsion. The tail section 14 of the robotic fish 10 is attached to the servomotor horn 72. The position of the servomotor horn 72 may be described in terms of degrees from a neutral position, say n. When the tail section 14 is not flapping, the position is considered to be 0 degrees, see FIG. 4(a). When swimming in a straight line, the tail section 14 would beat from −x degrees to +x degrees, passing through n=0, where x is the tail beat amplitude. To steer, the neutral position n is shifted in either direction from 0 degrees. For example, if the beating amplitude is x=20 degrees and if steering right with a small turning rate n=−20 degrees, see FIG. 4(b), the tail section 14 would beat from (x+n) to (−x+n) or (20+(−20)) to (−20+(−20)), hence, from 0 degrees to −40 degrees.

The robotic fish 10 can be used as an educational tool in the form of a kit comprising a robotic fish 10 and a remote control 50 system. The kits can be used to design interactive curricula and activities for K-12 students as a means to reinforce understanding and interest in STEM fields. Advanced modes of the system can be modified for use in undergraduate controls or mechatronics courses. Lower grade versions may be devised as a children's toy providing a remotely controlled robotic fish 10. The robotic fish 10 may be used as an educational tool in the illustrative ways shown in Table 1 in addition to public outreach:

TABLE 1
Illustrative educational applications for education level

| Education Level | Subject Matter | Possible Applications |
|---|---|---|
| Pre High School | Biology | Vary caudal fins - demonstrate |
| level | | how various fin shapes and |
| | | sizes from nature effect the |
| | | swimming speed and |
| | | performance of the robot |
| | Physics | Newton's Laws of motion - |
| | | compare the flapping of the fin |
| | | leading to thrust production to a |
| | | hand-held fan |
| | | Demonstrate positive effects of |
| | | friction and viscosity on animal |
| | | locomotion |
| High School | Electronics/ | Offer the robot as a build it |
| level/ | Mechatronics/ | yourself kit with expandable |
| Undergraduate | Robotics | sensors and hardware |
| level | Computer Science | Create custom graphical user |
| | | interfaces for robot operation |
| | | Program missions for the robot |
| | | Custom robot firmware for third |
| | | party hardware integration |
| Undergraduate | Automatic controls/ | General feedback control |
| level | Mechatronics/ | Use external sensors such as a |
| | Robotics | camera to design control |
| | | algorithms |
| | | For single-agent/multi-agent |
| | | system development and testing |
| | | Path-planning |
| | Measurement | Mobile sensing platform for |
| | Systems/ | class projects and |
| | Environmental | demonstrations |
| | Engineering | |
| | Fluid Dynamics | Demonstrate: drag, thrust, flow |
| | | visualization for vortex shedding |
| Graduate level | Nonlinear controls/ | Advanced single-agent/multi- |
| | Mechatronics/ | agent system development and |
| | Robotics | testing |
| | | Nonlinear controller design |
| | Experimental Fluid | Class projects and |
| | Dynamics | demonstrations |
| | Advances | Linear versus non-linear |
| | Vibrations | underwater vibrations in water |

The robotic fish 10 also can be used as a research tool. For example, the robotic fish 10 can serve as a low-cost autonomous underwater research vehicle for applications such as environmental mapping, single-agent/multi-agent system development, underwater control algorithm testing/validation, fluid-dynamics applications, etc.

### Example of Implementation of the Invention

The following exemplary implementation of the method of the invention is based on the development, organization, and execution of a robotics-based outreach program designed to ignite K-12 students' interest in science, technology, engineering, and mathematics (STEM) and to attract them toward engineering careers. The program consists of interactive fun-science activities for pre-high school students based on underwater robotics and marine science. The activity format and implementation revolves around ad-hoc designed, low-cost, remotely controlled, and miniature biomimetic fish-like robots. The robotic platform allows for multifaceted student engagement through direct guidance, design upgrade, and sporting competition. Support material for the activity, comprising pamphlets and posters, was developed by high school students, who also served as leading docents in the program. The survey results of the outreach program indicate the success of the activity in influencing the students' perception of engineering. By comparing self-reported survey responses before and after the event, the students showed an increased interest in STEM fields and found engineering to be a more accessible and exciting discipline after the activity.

I. Introduction. Engineering disciplines, such as biomedical, chemical, civil, electrical, and mechanical, are instrumental to society's well-being and technological competitiveness. To broaden the base of engineers for the future, it is critical to excite young minds about science, technology, engineering, and mathematics (STEM). Research that is easily visible to K-12 students, including underserved and minority populations with limited access to technology, is crucial to ignite their interests in STEM fields. More specifically, research topics that involve interactive elements such as robots may be instrumental for K-12 education in the classroom and outside the classroom.

Interactive robots have been successfully used in STEM education and outreach activities. In K-12 education, robots can be employed to teach formal subjects, such as physics and science, and to inspire an explicit engineering curriculum. Beyond integrating robotics into school curricula, outreach activities centered on exciting children and teenagers about STEM greatly benefit the tangibility that robots offer. That is, robotics-based activities administered to students outside of school environments, in the form of workshops and summer camps, are shown to positively influence the participants' understanding of engineering topics and further foster their interest in STEM fields. As an example, robots featured as keynote speakers during outreach and public events increase interest and information retention in the audience. The impact of robots in education is not limited to K-12 students, as robotics is extensively used in higher education to teach engineering principles and develop ‘design and compete’-type curricula.

Part of the research activities of the present inventors involves the design and implementation of underwater vehicles for marine studies. Potential applications of the research include developing effective strategies for coordination of low-cost multivehicle teams and studying animal robot interaction. Major efforts have been devoted to the guidance and control of gregarious fish using biomimetic robots. The overarching goal of these studies is to develop a comprehensive dynamical systems framework for the analysis and control of animal groups. The robotic fish 10 mimic live fish swimming and are easily operated using a remote control, making them a natural teaching tool for use with K-12 students.

Following is a narration of the fun-science activity exemplifying an embodiment of the method of the present invention. The format of the activity, which brings together K-12 students and robots, is unique in the authentic engineering experience it offers. The activity took place at the New York Aquarium (NYAQ) and took advantage of the stunning collection of fishes there to acquaint students with different modes of swimming. As per a real biologically inspired robot design, the students were introduced to robotic fish 10 and were encouraged to design and make caudal fins 18A for the robotic fish 10. The students tested these caudal fins 18A on the robotic fish 10 to ascertain the effect of caudal fin 18A size and shape on swimming.

The planning and implementation of the fun-science activity was enhanced by using two high school students with prior experience in the NYAQ's teen docent program. The high school students were able to act as liaisons between the elementary/middle school student participants and the inventors, while bringing intimate knowledge of the NYAQ to the planning of the activity. Additionally, locating this exemplary activity in Brooklyn, N.Y. and targeting local public schools for participation allowed impacting often underserved populations, whose access to engineering and science experiences can be limited by socioeconomic and cultural barriers.

II. Interactive Robotic Fish For Outreach. Past endeavors have brought forth remotely controlled biomimetic robotic fish propelled by ionic polymer metal composites (IPMCs) and powered by onboard batteries. IPMCs are a novel class of compliant smart materials that deform in response to a voltage signal applied across their electrodes. An IPMC strip in connection with a passive silicone fin at its tip comprises an artificial flapping tail for the robotic fish; this allows the robot to replicate the locomotion of carangiform swimmers such as goldfish or minnows.

The high cost of IPMC actuators limits the use of these vehicles in the classroom. In addition, IPMCs, in these early stages of development, are delicate materials which require careful use and storage and are not easily handled by children. Therefore, the inventors sought to develop a low cost and more resilient version of the biomimetic robotic fish. The result is a servomotor-driven, attractive, and child-friendly platform based on off-the-shelf electronics, as shown in FIG. 5. FIG. 6 is a perspective view of representative alternate embodiments of the robotic fish 10 of the present invention shown with an optional camera 26.

The servomotor-propelled robotic fish 10 are designed to swim at speeds comparable to that of the live fish which they are intended to mimic, approximately 1 body-length per second and have an approximate turning radius of 1 body-length. The robotic fish 10 are designed to be easily controlled by young participants using a video-game like remote control interface. Each robotic fish 10 is given a unique color for easy identification by the operator. Multiple robotic fish 10 may be operated simultaneously during race type events, as each one has its own designated remote control 50. The entire system costs under US$100 on a limited production basis, making the robotic fish 10 affordable for classroom implementation.

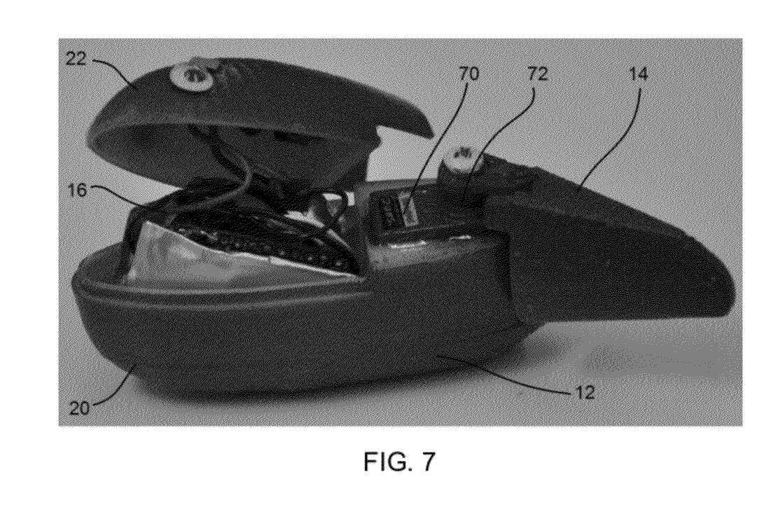

A. Robotic fish anatomy. The robotic fish 10 are comprised of an acrylonitrile butadiene styrene (ABS) plastic body shell 20, tail section 14, and body cap 22. The electronics 16 and battery for control and power are encased in the body shell 20, as shown in FIG. 7. The electronics 16 include a microcontroller unit, a wireless transceiver, power regulators, and a rechargeable battery. A servomotor 70, used to actuate the tail section 14 of the robotic fish 10, fits into a compartment at the back of the body shell 20. The tail section 14 is connected to the servomotor 70 using a standard servo horn 72 and provides a means to attach a customizable caudal fin 18A. The servomotor 70 preferably is waterproof and may operate underwater, provided that the inside of the body shell 20 is watertight for protection of the electronics 16 and for conservation of buoyancy. A counterweight composed of a thin strip of coated lead sits at the bottom of the body shell 20 to achieve neutral buoyancy and enhance pitch and roll stability. The body cap 22 provides access to the electronics compartment for initial assembly of the robotic fish 10 and preferably is permanently attached to the body shell 20 in the final robotic fish 10 implementation. A switch hidden behind the servomotor horn 72 allows the robotic fish 10 to be turned on and off and a power port is located at the back of the body shell 20 for charging. This configuration permits that the robotic fish 10 remains in its assembled form and does not require the body cap 22 to be removed during normal operation or for charging. The dimensions of the robotic fish 10 in this exemplary embodiment are approximately 117 mm in length, 48 mm in height, and 26 mm in width, without the customizable caudal fin 18A attached.

B. Robotic fish interactive features. The robotic fish 10 are controlled using a remote control user interface, an example of which is shown in FIGS. 3 and 4. The remote control 50 is enclosed in a transparent plastic case with all of its electronics visible to further enhance the learning experience. The remote control 50 contains a variety of inputs and outputs, giving the user the ability to control the robotic fish 10 locomotion. In particular, the tail beating frequency and amplitude may be modulated in addition to basic steering, forward, and stop commands. A video-game like joystick 54 provides steering control with left/right motions and control of the tail beating frequency with up/down motions. Additionally, a knob 56 allows for the selection of tail beating amplitude. LED lights 58 indicate when the remote control 50 is ready (green LED) and when the robotic fish 10 batteries are low (red LED). A toggle switch 60 is used to switch control from the manual control (joystick 54) to potential autonomous control (computer interface).

In its assembled form, the robotic fish 10 do not include a caudal fin 18A. This allows the user, in this case the students participating in the activity, to experience biologically-inspired design by cutting out their own caudal fin 18A from a premade template 18B, as shown in FIG. 1. The template 18B is constructed by ‘sandwiching’ a piece of paper and a 22 gage wire between two pieces of clear packing tape. The wire is used to secure the caudal fin template 18B into the tail section 14 of the robotic fish 10 by snugly fitting into a keyhole slot.

III. Educational Material for Outreach. The activity at the NYAQ included informative and interactive elements to ignite K-12 students' interest in technology and science and to attract them toward career opportunities in engineering. The program consisted of interactive fun-science activities at the NYAQ for elementary and middle school students based on underwater robotics and marine science, and it targeted the engaging intersection of these disciplines in the emerging field of biologically-inspired robotics. The activity was organized as a seventy-five minute event, including a tour of the NYAQ, an underwater robotics session, and an interactive engineering phase. Support material for the activity, comprising pamphlets and a poster, was developed by two high school students who also served as leading docents in the program.

A. Activity informative material. Two high school students, selected for their prior affiliation with the NYAQ through the teen docent program, worked on this program with a graduate student mentor for five hours per week. During this time, they first learned about the inventors' ongoing research projects through demonstration of experiments by laboratory members and consultation of posters and papers resulting from this research. In addition, they studied fundamental concepts in smart materials and fish physiology to understand elements of these fields which are salient for biomimetic robot design and application. At the same time, the high school students were cognizant of their role as a bridge between the knowledge of elementary and middle school students and the scientific community at the laboratory.

Using this information, the high school students created several documents. The first was an informative pamphlet designed for interested teachers. The pamphlet detailed the basic robotics research questions addressed by the inventors, including creating a biomimetic vehicle for implementation with live animals. Also, the pamphlet expressed the motivation behind the inventors' research with marine science background information and it outlined the proposed fun-science activity. The diction of the pamphlet was designed specifically for non-technical audiences, which is evidenced in the following quotation outlining fish locomotion:
Fish swim in a variety of ways. Stingrays, for example, flap their fins like wings to glide on the bottom of the ocean floor. Eels, on the other hand, wriggle like snakes to get where they're going. The fish that we are going to focus on use a form of locomotion called carangiform. These fish are what we normally picture in our heads when we think of fish. To move in their environment, these fish wave their bodies like a flag. The ability to swim in this manner allows for some members of this class of fish to school (or swim in a group for protection).

The other educational document prepared by the high school students was a large 3′×2′ poster offering an overview of the inventors' research, which also drew from their study on fish physiology. The colorful poster was informally presented by the high school students during the activity and was written using age-appropriate language and concepts. Adhering to this restriction, the high school students accurately described such high level ideas as the basic principles behind the IPMCs.

B. Activity interactive material. In accompaniment with the robotic fish 10, the high school students created caudal fin templates 18B from which the participants were able to construct their own biologically-inspired caudal fins 18A, as shown in FIG. 1. The caudal fins 18A can be easily inserted into the keyhole slot on the robotic fish 10 tail section 14 to allow for quick trials of each student's caudal fin 18A. Caudal fin templates 18B were prepared for each student to have several tries.

The high school students also realized a testing pool for the robotic fish 10, comprising a large plastic storage container. The container was divided into three lanes by colorful buoys and twine, giving it the effect of a miniature swimming pool. In addition, the high school students created a ‘finish line’ from a flag hoisted between two wooden dowels at one end of the pool. This allowed the participants an arena to test their caudal fins 18A on the robotic fish 10 and compete their caudal fins 18A against one another via the simultaneous operation of two robotic fish 10 in the pool.

C. Activity format. The format of the activity at the NYAQ had both live and robotic fish 10 experiences. Upon entering the NYAQ, each class was directed to the Glover's Reef exhibit which mimics a real Belizean environment. The students observed fish characterized by different types of swimming modalities, including eels, rays, wrasses, and chromises, for approximately fifteen minutes. An aquarium educator guided their observations towards the different types of locomotion animals underwater may use to move in their environment. The class was then asked to think about what characteristics of body or motion are required to make a fish swim quickly.

When the tour adjourned, the students were lead to an education building at the aquarium, where several stations were prepared along with a robotic fish test platform. The classes were given a few minutes of instruction outlining the stations, which comprised the fin-making station, the testing pool station, the research station, the engineering station, and the survey station.

A typical route for a student through the activity was as follows. The student first went to the fin-making station, where he or she cut a caudal fin 18A out of a fin template 18B based on what he or she had observed during the tour. The student then walked to the testing pool station and was assisted in mounting this caudal fin 18A on the robotic fish 10 and controlling the swimming of the robotic fish 10 using a remote control 50. After this experimental trial, the student walked to the research station where he or she was guided through the poster by one of the high school students, who explained the significance of robotic fish 10 in the inventors' research. At this station, the student also observed videos of the IPMC-actuated robotic fish developed by the inventors. From this point, the student walked to the engineering station to see and handle disassembled robot parts, including circuit boards, servomotors, IPMCs, and plastic hulls. Here, the student had an explicit opportunity to ask questions he or she might have. Lastly, the student went to the survey station and answered the survey prepared for the activity.

At the end of the visit, the students were thanked for their time, attention, and enthusiasm, and informed that their survey answers would be used to assess the strengths and weaknesses of the activity. In addition, any remaining questions of the students were answered.

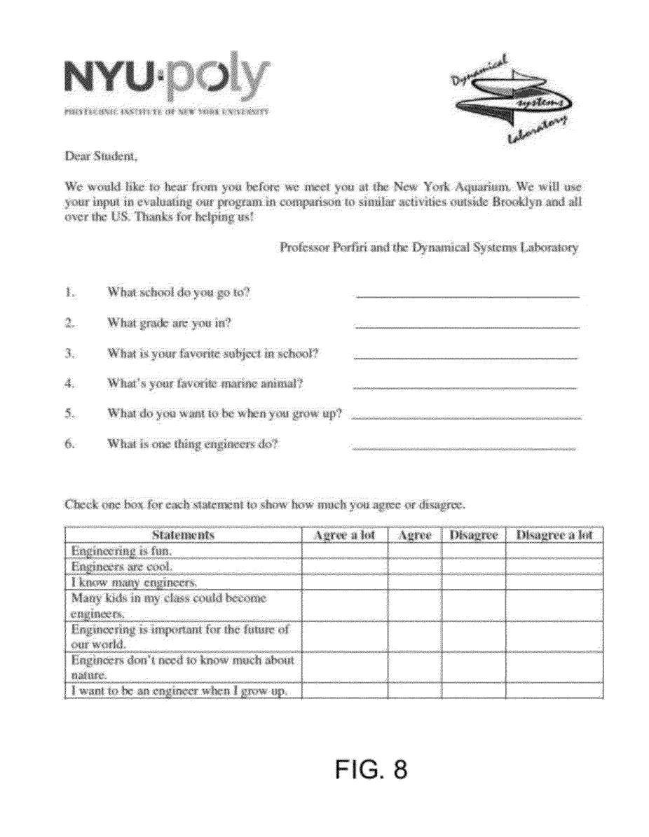

IV. Results of the Program. Students were given two surveys, one several days before participating in the activity, called the preassessment, and one immediately after, called the postassessment. An image of the preassessment given before the activity is shown in FIG. 8. The preassessment is partitioned into two sections: fill-in-the-blank questions and statements S1 to S7: S1: “Engineering is fun”; S2: “Engineers are cool”; S3: “I know many engineers”; S4: “Many kids in my class could become engineers”; S5: “Engineering is important for the future of our world”; S6: “Engineers don't need to know much about nature”; and S7: “I want to be an engineer when I grow up”, with which students must rate their agreement. The postassessment included fill-in-the-blank questions and statements S1 to S7 as well as statements S8 to S10: S8: “I learned a lot today”; S9: “I would like to have more engineering presentations like this one in the future”; and S10: “Today's visit made engineering look fun”, and a drawing component. The surveys were intended to analyze the students' notion/understanding of engineering professions, their interest in STEM careers, and the feasibility of these careers to them.

The fill-in-the-blank questions asked for basic demographic information, which school and grade is attended by the student, as well as a ‘comfort question’, what the student's favorite marine animal is, which was designed to put the student at ease while completing the survey. The relevant questions for assessing change in the student's perception of STEM asked for the student's favorite subject in school, for what the student wants to be when he or she grows up, and for one thing that engineers do.

A total of sixty-two students from a fourth grade class and a sixth grade class were surveyed before visiting the aquarium, and fifty students participated in the fun-science activity. The ages and socioeconomic backgrounds of students in both classes, separately participating in the activity over two days, were parallel as both classes come from public schools within one mile of one another. In light of this similarity, their surveys were combined to afford a larger sample of preassessment and postassessment responses analyzed.

The responses for favorite school subject were partitioned into STEM and non-STEM disciplines, with multiple responses considered STEM if they included at least one STEM discipline. Blank responses were discarded. The preassessment showed 71% of surveyed students preferring STEM fields and 29% preferring non-STEM fields. The postassessment suggested an increase in STEM preference, with 80% of students preferring STEM to 20% preferring non-STEM.

The responses for career aspirations, what the students would like to be when they grow up, were also partitioned into STEM and non-STEM fields. Multiple responses are counted as STEM if they included at least one STEM career. If “doctor” is considered a STEM profession, then a decline from 45% of students considering STEM careers before the activity to 38% after the activity was observed. However, excluding “doctor” responses, the STEM careers to which the students aspired rose from 21% to 26% of the remaining responses, which hinted at an increased interest in the less visible STEM professions. Additionally, of the non-STEM careers favored by the participants, approximately 25% chose police officer or “undercover cop” consistently in the preassessment and postassessment, which speaks to the more visible careers in their socioeconomic environment.

Student answers to the question “What is one thing engineers do?” shed light on the changing perceptions after the fun-science activity. Perhaps due to confusion over the difference between a mechanic and a mechanical engineer, 23% of students in the preassessment gave automotive-related responses to this question, such as fix or make cars. However, the postassessment shows only 13% of students had automotive-related answers. Additionally, the students' responses were partitioned into three thematic subsets: fabrication (“make things”), maintenance (“fix things”), and other. The preassessment showed 39% fabrication, 49% maintenance, and 12% other. The postassessment showed a shifting distribution, with 46% fabrication, 30% maintenance, and 24% other. The “other” responses were generally discovery-oriented, such as “invent things”, “design new things”, “discover things and modeling”, and “build models of things they are going to do”. These responses in particular may be the result of students internalizing the basic scientific method by simultaneous exposure to many aspects of the design process during the event at the NYAQ.

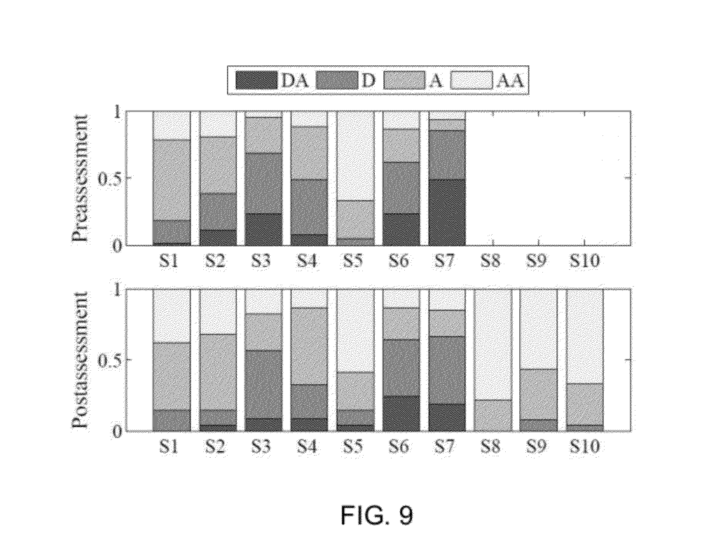

FIG. 9 shows stacked bar graphs representing the distribution of students' agreement or disagreement with statements S1 to S7 on the preassessment and S1 to S10 on the postassessment, with AA denoting “agree a lot”, A denoting “agree”, D denoting “disagree”, and DA denoting “disagree a lot”. As above, statements without response, or with multiple responses to the same statement, were excluded from this analysis. S1 and S2 were designed to test the perception of the engineering discipline. S3 asked for demographic information about the students' personal ties to engineering professionals. S4 was written to test the accessibility of engineering as a career to the students. S5 and S6 sought to garner information about the importance of engineering. S7, which reads “I want to be an engineer when I grow up”, explicitly inquired as to the students' desire to pursue careers in engineering. Additional statements S8, S9, and S10 were included in postassessment surveys.

Broadly examining the distributions in FIGS. 9, S1 and S4 show trends toward more agreeable perception after the activity. S5 and S6 stay relatively constant before and after the activity and S7 shows a remarkable shift toward agreement in the postassessment. These trends are consistent with the pre-activity hypotheses that S1, S2, S4, S5, and S7 show positive shift and S6 shows a negative shift as a result of the activity. The seeming trend in S3 is not part of the set hypotheses and is rather an observation of students' engineering climate.

For a statistical perspective on this data, a nonparametric Mann-Whitney U test was performed to ascertain the statistical significance of the differences observed between the preassessment and the postassessment responses. This test is selected among others since it can be used to extract quantitative information from surveys whose answers are ordinal and non-numerical. The p-values with p<0.05 are taken to be statistically significant, 0.05≦p<0.10 to be weakly statistically significant, and p≧0.10 to be not statistically significant. The p-values computed for statements S1, S2, and S4 to S7 are respectively 0.077, 0.036, 0.077, 0.107, 0.036, and 0.077. This shows that the positive and negative shifts of responses to statements S2 and S6 respectively are statistically significant and the positive shift of responses to S1, S4, and S7 are weakly statistically significant. Only the positive shift in S5 shows no statistical significance, although its p-value is close to the threshold of 0.10. These results provide statistical support to the observed enthusiasm and excitement of students during the activity.

In addition, the postassessment included three statements S8 to S10 to ascertain the students' perception of the fun-science activity itself. From the overwhelmingly positive response to these three questions, it was seen that the students had an interest in STEM fields, found engineering to be an accessible discipline, and had fun participating in the activity.

To allow less verbal students an opportunity to express what they learned from the activity, the postassessment included a drawing component in which the students were asked to draw their own robotic fish 10 using colored pencils. The various caudal fin 18A shapes drawn evidenced that the exercise of modifying fin shape to test the influence on swimming informed the students' design in their fish sketches.

V. Conclusions. In this activity illustrating the method of the present invention, the format, experience, and results of an interactive robotics-based outreach activity designed to ignite the interests of K-12 students in STEM fields and attract them towards careers in engineering have been exemplified. The activity engaged to local elementary school and middle school classes at the NYAQ. The participating students were given a guided tour of fish exhibits at the NYAQ with a short lecture on live fish swimming mechanisms, then asked to use their creativity and knowledge of fish to engineer and test caudal fins 18A on robotic fish 10.

The materials created for the activity comprise promotional brochure, a poster developed by two high school students, and biomimetic robotic fish 10 used during the interactive engineering phase. The robotic fish 10 included modular features which allowed participants to design and test their own biologically-inspired caudal fins 18A. Using a remote control 50, these robotic fish 10 provided a perfect platform to ignite interest in engineering activities. The impact of the activity on the student participants was assessed using self-report surveys administered to students before and after the activity.

Survey results showed a clear impact of the activity in fostering positive perceptions of engineering professions, increased interest in STEM careers, and openness of these careers to the students. This success can be attributed to the simultaneous orchestration of the following elements: i) use of visually attractive and interactive robots; ii) active involvement in authentic biologically-inspired engineering design; iii) integration of robotics and marine science; iv) informal setting for STEM learning at the NYAQ; v) participation of an age and gender diverse cadre of university and high school students; and vi) distribution and on-site presentation of educational material prepared by high school students bridging college with middle/elementary school learning.

Thus, the biomimetic robotic fish 10 finds additional applications as a tool for engineering outreach. In a series of bio-inspired design activities, students participated in observations of live marine animal locomotion and designed a custom caudal fin 18A for the robotic fish 10 based on these observations. Due in part to the integration of the robotic fish 10 in this activity, students showed a significant increased interest in science, technology, engineering, and mathematics disciplines and found these professions to be more accessible as assessed by pre- and post-activity surveys.

One embodiment of the invention is a method for scientific education comprising using a remotely controlled biomimetic robotic fish 10 having modular features that allow interaction with the design of the robotic fish 10 based on observation of nature, and designing or creating the modular features. The movements of the remotely controlled biomimetic robotic fish 10 can be programmed using a computer. A user or student can design or create a graphical user interface for interacting with the remotely controlled biomimetic robotic fish 10. The method can comprise remotely operating the robotic fish 10 in a water environment using a remote control device.

The modular features of the robotic fish 10 can comprise at least one caudal fin 18A that is removably attached to the robotic fish 10. A user or student can create a first design for a first one of the at least one caudal fin 18A, attach the first caudal fin 18A to the robotic fish 10, and observe how the first caudal fin 18A propels the robotic fish 10. The user or student also can create a second design for a second one of the at least one caudal fin 18A, replace the first caudal fin 18A with the second caudal fin 18A, and observe and compare to each other how each of the first caudal fin 18A and the second caudal fin 18A propels the robotic fish 10 in a water environment.

Alternatively, a user or student can create a first design for a first one of the at least one caudal fin 18A, create a second design for a second one of the at least one caudal fin 18A, attach the first caudal fin 18A to a first one of the robotic fish 10, attach the second caudal fin 18A to a second one of the robotic fish 10, and observe and compare to each other how the first caudal fin 18A and the second caudal fin 18A propel the respective robotic fish 10 in a water environment.

Another embodiment of the invention is a remotely controlled biomimetic robotic fish 10 for scientific and educational purposes, the remotely controlled biomimetic robotic fish 10 comprising modular features that allow interaction with the design of the robotic fish 10 based on observation of nature, wherein one of the modular features is a caudal fin 18A. The robotic fish 10 can comprise a template 18B for designing the caudal fin 18A, and can further comprise a means for attaching 24 the caudal fin 18A to the robotic fish 10. Additionally, in certain embodiments, the invention comprises means for interfacing with a computer and for controlling the robotic fish 10 with a computer program.

The remotely controlled biomimetic robotic fish 10 preferably comprises a body section 12 comprising a body shell 20 and a body cap 22 for containing electronics 16 for operating the robotic fish 10, a tail section 14 on which the caudal fin 18A is removably attached, a motor 70 within the body section 12, and means for controlling the motor/actuator within the body section 12. The tail section 14 preferably is attached to the motor 70 whereby the motor 70 causes the tail section 14 to move in a manner simulating a natural tail motion of a fish. The motor 70 preferably is controlled to move the tail section 14 within a prescribed arc so as to propel and to steer the robotic fish 10 in a manner simulating a natural swimming motion of a fish.

Yet another embodiment of the invention is a system for scientific and educational purposes comprising a remotely controlled biomimetic robotic fish 10 and a remote control 50 for remotely controlling the biomimetic robotic fish 10. The system can further comprise a computer featuring and/or comprising computer software for controlling the robotic fish 10 and the robotic fish 10 having the capacity to interface with the computer and to be controlled by the computer program. Preferably, the system is adjustable depending on the grade and knowledge of the user.

The robotic fish 10 of the system preferably comprises modular features, such as a caudal fin 18A that is removably attached to the robotic fish 10. The caudal fin 18A can be designed using a template 18B. A means for removably attaching 24 the caudal fin 18A to the robotic fish 10 can be used to attach the caudal fin 18A to the tail section 14 of the robotic fish 10, such a means being any common means such as a clip, a male-female connection means, adhesives, and the like.

The system preferably further comprises a method for scientific education comprising using the remotely controlled biomimetic robotic fish 10 having modular features that allow interaction with the design of the robotic fish 10 based on observation of nature, and designing or creating the modular features, and the robotic fish 10 as disclosed above.

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

What is claimed is:

1. A method for scientific education comprising:
using a remotely controlled biomimetic robotic fish having modular features that allow interaction with the design of the robotic fish based on observation of nature; and
designing or creating the modular features.

2. The method as claimed in claim 1, further comprising programming movements of the remotely controlled biomimetic robotic fish using a computer.

3. The method as claimed in claim 2, further comprising designing or creating a graphical user interface for interacting with the remotely controlled biomimetic robotic fish.

4. The method as claimed in claim 3, wherein the modular features comprise at least one caudal fin that is removably attached to the robotic fish.

5. The method as claimed in claim 4, further comprising:
creating a first design for a first one of the at least one caudal fin;
attaching the first caudal fin to the robotic fish; and
observing how the first caudal fin propels the robotic fish.

6. The method as claimed in claim 5, further comprising:
creating a second design for a second one of the at least one caudal fin;
replacing the first caudal fin with the second caudal fin; and
observing and comparing to each other how each of the first caudal fin and the second caudal fin propels the robotic fish in a water environment.

7. The method as claimed in claim 4, further comprising:
creating a first design for a first one of the at least one caudal fin;
creating a second design for a second one of the at least one caudal fin;
attaching the first caudal fin to a first one of the robotic fish;
attaching the second caudal fin to a second one of the robotic fish; and
observing and comparing to each other how the first caudal fin and the second caudal fin propel the respective robotic fish in a water environment.

8. The method as claimed in claim 6, further comprising remotely operating the robotic fish in a water environment using a remote control device.

9. The method as claimed in claim 7, further comprising remotely operating the robotic fish in the water environment using a remote control device.

10. A remotely controlled biomimetic robotic fish for scientific and educational purposes, the remotely controlled biomimetic robotic fish comprising modular features that allow interaction with the design of the robotic fish based on observation of nature, wherein one of the modular features is a caudal fin.

11. The remotely controlled biomimetic robotic fish as claimed in claim 10, further comprising a template for designing the caudal fin.

12. The remotely controlled biomimetic robotic fish as claimed in claim 11, further comprising a means for attaching the caudal fin to the robotic fish.

13. The remotely controlled biomimetic robotic fish as claimed in claim 5, further having means for interfacing with a computer and for controlling the robotic fish with a computer program.

14. The remotely controlled biomimetic robotic fish as claimed in claim 10, further comprising at least two of the caudal fins.

15. The remotely controlled biomimetic robotic fish as claimed in claim 11, further comprising:
a body section comprising a body shell and a body cap for containing electronics for operating the robotic fish;
a tail section on which the caudal fin is removably attached;
a motor within the body section; and
means for controlling the motor within the body section,
wherein the tail section is attached to the motor whereby the motor causes the tail section to move in a manner simulating a natural tail motion of a fish, and
wherein the motor is controlled to move the tail section within a prescribed arc so as to propel and to steer the robotic fish in a manner simulating a natural swimming motion of a fish.

16. A system for scientific and educational purposes comprising a remotely controlled biomimetic robotic fish and a remote control for remotely controlling the biomimetic robotic fish.

17. The system as claimed in claim 16, further comprising a computer comprising computer software for controlling the robotic fish and the robotic fish having the capacity to interface with the computer and to be controlled by the computer program.

18. The system as claimed in claim 16, wherein the system is adjustable depending on the grade and knowledge of the user.

19. The system as claimed in claim 16, wherein the robotic fish comprises modular features, the modular features comprising a caudal fin that is removably attached to the robotic fish.

20. The system as claimed in claim 19, further comprising a template for designing the caudal fin.

21. The system as claimed in claim 20, further comprising a means for removably attaching the caudal fin to the robotic fish.

22. The system as claimed in claim 22, wherein the robotic fish further comprises:
a body section comprising a body shell and a body cap for containing electronics for operating the robotic fish;
a tail section on which the caudal fin is removably attached;
a motor within the body section; and
means for controlling the motor within the body section,
wherein the tail section is attached to the motor whereby the motor causes the tail section to move in a manner simulating a natural tail motion of a fish, and
wherein the motor is controlled to move the tail section within a prescribed arc so as to propel and to steer the robotic fish in a manner simulating a natural swimming motion of a fish.

23. The system as claimed in claim 22, further comprising:
creating a first design for a first one of the at least one caudal fin;
attaching the first caudal fin to the robotic fish; and
observing how the first caudal fin propels the robotic fish.

24. The method as claimed in claim 23, further comprising:
creating a second design for a second one of the at least one caudal fin;
replacing the first caudal fin with the second caudal fin; and
observing and comparing to each other how each of the first caudal fin and the second caudal propels the robotic fish in a water environment.

25. The system as claimed in claim 22, further comprising at least two of the caudal fins.

26. The method as claimed in claim 25, further comprising:
creating a first design for a first one of the at least two caudal fins;
creating a second design for a second one of the at least two caudal fin;
attaching the first caudal fin to a first one of the robotic fish;
attaching the second caudal fin to a second one of the robotic fish; and
observing and comparing to each other how the first caudal fin and the second caudal fin propel the respective robotic fish in a water environment.
